(19) United States
(12) Patent Application Publication
(10) Pub. No.: US 2012/0224934 A1
(43) Pub. Date: Sep. 6, 2012

(54) FASTENER

(75) Inventor: Peter J.H. CHANG, Taipei (TW)

(73) Assignee: GOURMET EQUIPMENT (TAIWAN) CORPORATION, Taipei (TW)

(21) Appl. No.: 13/406,922

(22) Filed: Feb. 28, 2012

(30) Foreign Application Priority Data
Mar. 1, 2011 (TW) 100203550

(51) Int. Cl. F16B 39/04

(52) U.S. Cl. 411/315

(57) ABSTRACT

A fastener for securing a wheel rim to an automobile axle unit includes a shank segment, a hollow head segment and a securing pin. The shank segment has first and second threaded end portions and a smooth stop portion interconnecting the first and second threaded end portions. The head segment is formed with an internal thread engaged with the first threaded end portion, and has an abutting portion adapted to abut against the wheel rim and having a cross-section converging toward an open end thereof. The securing pin extends through the head segment into the shank segment for securing the head segment to the shank segment.

### CROSS-REFERENCE TO RELATED APPLICATION

This application claims priority of Taiwanese Application No. 100203550, filed on Mar. 1, 2011.

### BACKGROUND OF THE INVENTION

1. Field of the Invention

The invention relates to a fastener, more particularly to a fastener for securing a wheel rim to an automobile axle unit.

2. Description of the Related Art

With the growth of economy and personal income, automobiles nowadays are not only for transportation use, but are also often modified for personal styles and characteristics.

A popular modification of automobiles is to replace the original wheel rims with ones made of different materials (e.g., aluminum alloy) for their characteristic inherent colors.

Referring to FIG. 1, since a fastener 95 for fastening a wheel rim 92 to a connecting seat 94 is generally made integrally of alloy steel, color treatment of the fastener 95 to match the inherent color of the wheel rim 92 may be difficult.

### SUMMARY OF THE INVENTION

Therefore, the object of the present invention is to provide a fastener that can be easily manufactured to have a desired color for matching wheel rims with different colors.

Accordingly, a fastener of the present invention is adapted for securing a wheel rim to an automobile axle unit. The automobile axle unit is formed with a threaded hole. The fastener comprises a shank segment, a hollow head segment and a securing pin.

The shank segment is adapted to extend through the wheel rim and has a first threaded end portion, a second threaded end portion adapted to be engaged threadedly the threaded hole of the automobile axle unit, and a smooth stop portion interconnecting the first and second threaded end portions.

The head segment is formed with an internal thread that is engaged threadedly with the first threaded end portion of the shank segment, and is positioned relative to the shank segment by the stop portion of the shank segment. The head segment has an abutting portion that is adapted to abut against the wheel rim and that has an open end and a cross-section converging toward the open end.

The securing pin extends through the head segment into the shank segment for securing the head segment to the shank segment.

### BRIEF DESCRIPTION OF THE DRAWINGS

Other features and advantages of the present invention will become apparent in the following detailed description of the two preferred embodiments with reference to the accompanying drawings, of which:

FIG. 1 is a fragmentary exploded perspective view showing a conventional fastener, a wheel rim and an automobile axle unit;

FIG. 2 is a fragmentary exploded perspective view showing a first preferred embodiment of a fastener according to the present invention, a wheel rim and an automobile axle unit;

FIG. 3 is an exploded perspective view of the first preferred embodiment;

FIG. 4 is a fragmentary partly sectional view illustrating an assembly relationship of the fastener of the first preferred embodiment, the wheel rim and the automobile axle unit;

FIG. 5 is a side view of a securing pin of the first preferred embodiment;

FIG. 6 is an exploded perspective view of the second preferred embodiment according to the present invention; and

FIG. 7 is a fragmentary partly sectional view illustrating an assembly relationship of the fastener of the second preferred embodiment, the wheel rim and the automobile axle unit.

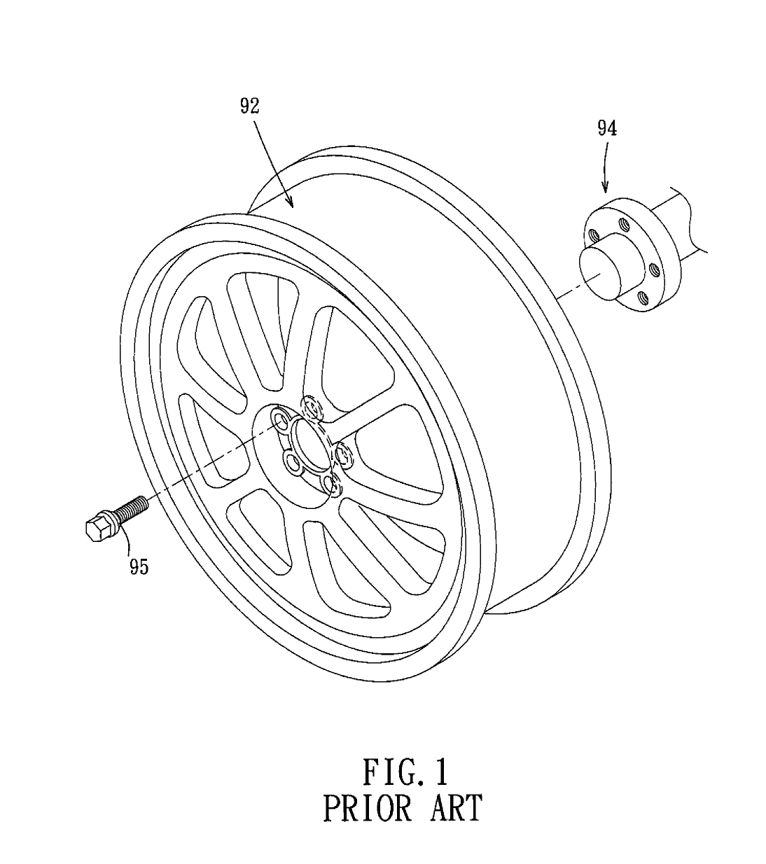

### DETAILED DESCRIPTION OF THE PREFERRED EMBODIMENTS

Before the present invention is described in greater detail, it should be noted that like elements are denoted by the same reference numerals throughout the disclosure.

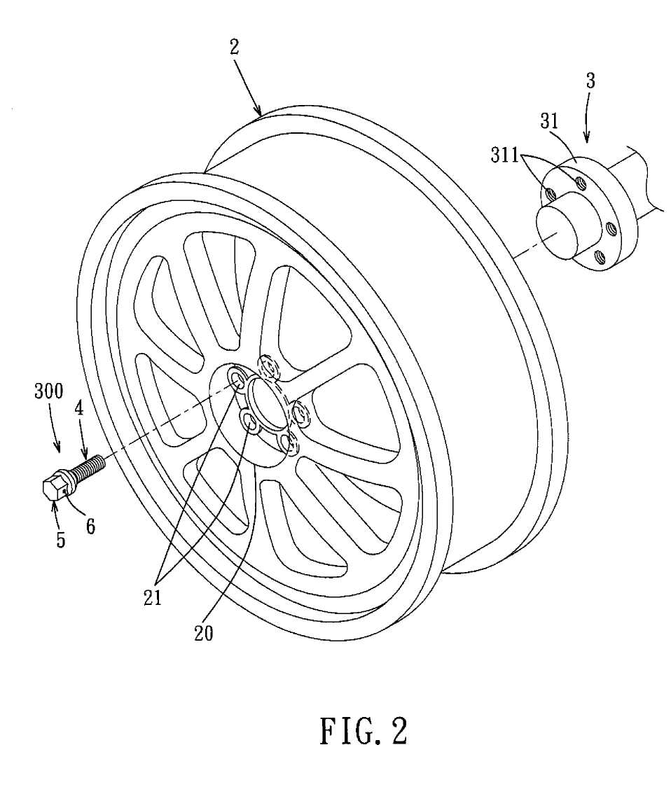

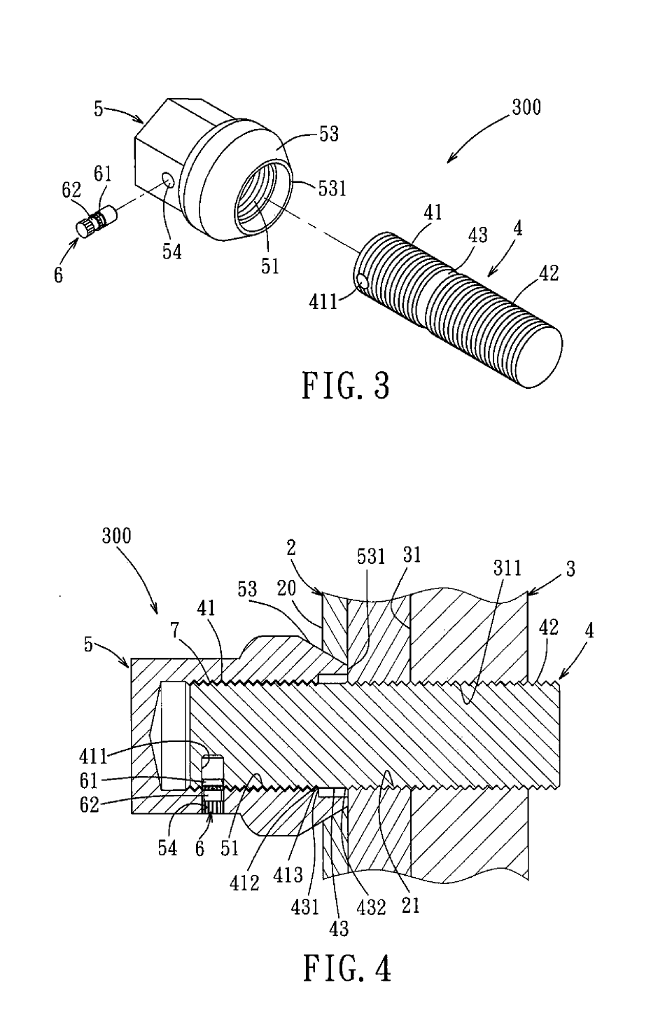

Shown in FIGS. 2, 3 and 4, is a first preferred embodiment of a fastener 300 for securing a wheel rim 2 to a connecting seat 31 of an automobile axle unit 3, according to the present invention. The connecting seat 31 has a plurality of threaded holes 311. The wheel rim 2 has a hub portion 20 formed with a plurality of through holes 21 that correspond respectively in position to the threaded holes 311 of the connecting seat 31, and that are configured respectively as threaded through holes in this embodiment. The fastener 300 includes a shank segment 4, a hollow head segment 5 and a securing pin 6.

The shank segment 4 is to be extended through one of the through holes 21 of the wheel rim 2, is made of alloy steel, and has first and second threaded end portions 41, 42, and a smooth stop portion 43 that has opposite first and second ends 431, 432 connected respectively to the first and second threaded end portions 41, 42. The second threaded end portion 42 is to be extended threadedly through the through hole 21 for threadedly engaging the threaded hole 311 of the connecting seat 31.

The head segment 5 is made of aluminum alloy and may be subjected to color treatment processes (e.g., anodizing). The head segment 5 is formed with an internal thread 51 for threadedly engaging the first threaded end portion 41 of the shank segment 9, and is positioned relative to the shank segment 4 by the stop portion 43 of the shank segment 4. The head segment 5 has an abutting portion 53 that is adapted to abut against the hub portion 20 of the wheel rim 2, and that has an open end 531 and a cross-section converging toward the open end 531. The abutting portion 53 disclosed in this embodiment is, but not limited to be, frustoconical. It may also be hemispherical or other shapes as long as the cross-section thereof decreases toward the open end 531.

In this embodiment, the stop portion 43 of the shank segment 9 has a uniform diameter larger than a thread root diameter 413 of the first threaded end portion 91 and smaller than a thread crest diameter 412 of the same, such that the internal thread 51 is stopped from being further threadedly extended toward the second threaded end portion 42 when a distal end of the internal thread 51 reaches the stop portion 43 without reaching the second threaded end portion 42, the stop portion 43 is surrounded by abutting portion 53 of the head segment 5 with the second end 432 being registered with the open end 531.

The head segment 5 has an inner surrounding surface on which the internal thread 51 is formed, and an outer surrounding surface, and is further formed with a pin hole 54 through such as drilling. The pin hole 54 thus formed extends through the inner and outer surrounding surfaces of the head segment 5. The first threaded end portion 41 is formed with a positioning hole 411 that coincides with the pin hole 54 and that is in spatial communication with the pin hole 54 when the first threaded end portion 51 is threadedly engaged with the head segment 5, thereby enabling extension of the securing pin 6 through the pin hole 54 into the positioning hole 411 for reinforcing the threaded engagement between the head segment 5 and the first threaded end portion 51. Preferably, both the pin hole 54 and the positioning hole 411 have a diameter slightly smaller than that of the securing pin 6.

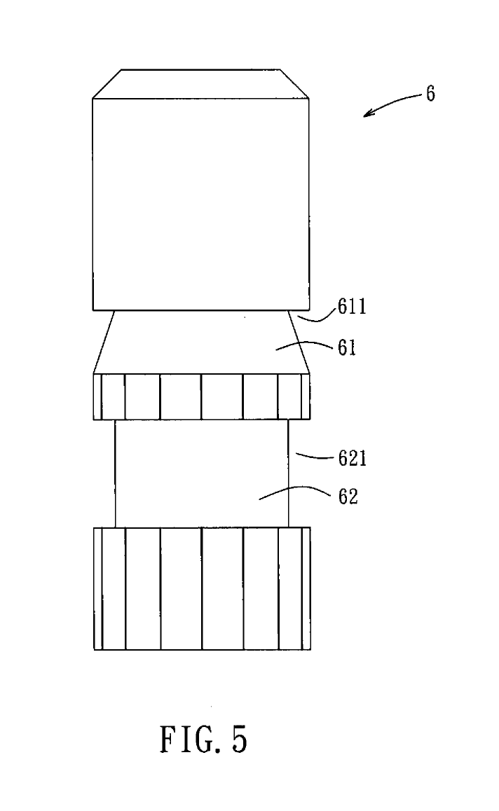

Further referring to FIG. 5, the securing pin 6 has a frustoconical-shaped inner section 61 and a cylindrical-shaped outer section 62 that are respectively formed with inner and outer annular grooves 611, 621. When the securing pin 6 is extended through the pin hole 54 into the positioning hole 411, the inner and outer annular grooves 611, 621 correspond in position to the positioning hole 411 of the first threaded end portion 41 and the pin hole 54 of the head segment 5, respectively. The outer section 62 has a diameter smaller than that of the pin hole 54. The inner and outer annular grooves 611 and 621 serve to collect metal dust that comes off the first threaded end portion 41 and the head segment 5 as the securing pin 6 is extended through the pin hole 54 into the positioning hole 411, which facilitates extension of the securing pin 6 through the pin hole 54 into the positioning hole 411 and ensures a firm assembly of the securing pin 6, the head segment 5 and the shank segment 4.

It should be noted that, prior to engaging the head segment 5 with the first threaded end portion 41 of the shank segment 4, an anaerobic adhesive layer 7 may be disposed (e.g., adhered) onto the internal thread 51 (see FIG. 4) for reinforcing the connecting strength between the head segment 5 and the first threaded end portion 41.

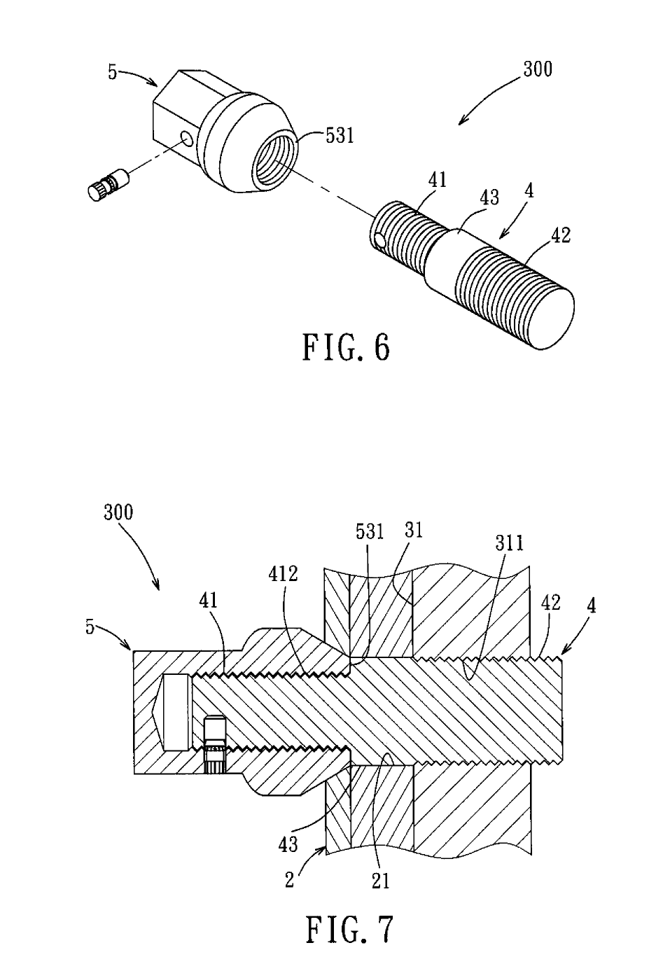

Referring to FIGS. 6 and 7, a second preferred embodiment of a fastener 300 of the present invention has a structure similar to that of the fastener 300 of the first preferred embodiment. The difference between the second preferred embodiment and the first preferred embodiment resides in that the diameter of the stop portion 43 of the shank segment 4 is larger than the thread crest diameter 412, such that, when the head segment 5 is threadedly engaged with the first threaded end portion 41 of the shank segment 4, the open end 531 of the head segment 5 abuts against the stop portion 43.

Each of the through holes 21 of the wheel rim 2 has a smooth inner surface, and the stop portion 43 has a length equal to that of the through holes 21. Thus, the second threaded end portion 42 of the shank segment 4 can be extended smoothly through the corresponding through hole 21 for engaging threadedly the corresponding threaded hole 311 of the connecting seat 31.

In summary, the head segment 5 is suitable to be subjected to color treatment to match the wheel rim 2 in color, and is to be threadedly engaged to the shank segment 4. The securing pin 6 may be extended through the pin hole 54 into the positioning hole 411 for securing the head segment 5 and the shank segment 4 in place with respect to each other. Further, the anaerobic adhesive layer 7 serves to reinforce the connecting strength between the head segment 5 and the shank segment 4.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A fastener adapted for securing a wheel rim to an automobile axle unit, the automobile axle unit formed with a threaded hole, said fastener comprising:
a shank segment adapted to extend through the wheel rim and having
a first threaded end portion,
a second threaded end portion that is adapted to be engaged threadedly the threadedhole of the automobile axle unit, and
a smooth stop portion that interconnects said first and second threaded end portions;
a hollow head segment formed with an internal thread that is engaged threadedly with said first threaded end portion of said shank segment, positioned relative to said shank segment by said stop portion of said shank segment, and having an abutting portion that is adapted to abut against the wheel rim and that has an open end and a cross-section converging toward said open end; and
a securing pin extending through said head segment into said shank segment for securing said head segment to said shank segment.

2. The fastener as claimed in claim 1, the wheel rim having a hub portion that is formed with a through hole registered with the threaded hole of the automobile axle unit for allowing extension of said shank segment therethrough, wherein;
said shank segment is configured as a rod, said stop portion of said shank segment has a diameter larger than that of said first threaded end portion of said shank segment and not smaller than that of said second threaded end portion of said shank segment; and
said stop portion has a length equal to that of the through holes of the wheel rim.

3. The fastener as claimed in claim 1, further comprising an anaerobic adhesive layer provided between said internal thread of said head segment and said first threaded end portion of said shank segment.

4. The fastener as claimed in claim 1, wherein said head segment is made of aluminum alloy.

5. The fastener as claimed in claim 1, wherein:
said head segment is further formed with a pin hole;
said first threaded end portion of said shank segment is formed with a positioning hole that is registered with said pin hole of said head segment; and
said securing pin has a diameter slightly larger than internal diameters of said positioning hole and said pin hole.

6. The fastener as claimed in claim 5, wherein said securing pin is formed with an annular groove.

7. The fastener as claimed in claim 5, wherein said annular groove of said securing pin corresponds in position to one of said pin hole and said positioning hole.
